(19) United States
(12) Patent Application Publication
(10) Pub. No.: US 2024/0325229 A1
(43) Pub. Date: Oct. 3, 2024

(54) PELVIC/WAIST PROTECTOR AND ELECTRIC INVERSION TABLE USING THE SAME

(71) Applicants: Jung Miin GO, Daejeon (KR); Kyung Ju KWON, Daejeon (KR); So Yeon GO, Daejeon (KR)

(72) Inventors: Jung Miin GO, Daejeon (KR); Kyung Ju KWON, Daejeon (KR); So Yeon GO, Daejeon (KR)

(21) Appl. No.: 18/280,953

(22) PCT Filed: Mar. 4, 2022
(86) PCT No.: PCT/KR2022/003101

§ 371 Date: Sep. 8, 2023

(30) Foreign Application Priority Data
Mar. 9, 2021 (KR) 10-2021-0030853

(51) Int. Cl. A61H 1/02

(52) U.S. Cl. CPC A61H 1/0229; A61H 2201/0103; A61H 2201/0192; A61H 2201/1215; A61H 2201/163; A61H 2201/1671; A61H 2203/0493

(57) ABSTRACT

The present invention relates to a pelvic/waist protector and an electric inversion table using same, the pelvic/waist protector including: a belt main body of which the length extends at both ends thereof so that an inner surface of the belt main body wraps around the pelvis and waist of a user; an air tube which is disposed on the inner surface of the belt main body, and of which the volume is variable by a fluid; and dispersion members which extend downward to the belt main body, in which the dispersion members are formed so as to be pulled toward the lower side of the waist of the user, and thus, the weight of the user may be supported by the pelvis and waist when exercising.

### TECHNICAL FIELD

The present invention relates to a pelvic/waist protector and an electric inversion table using the same, and more specifically, to a pelvic/waist protector worn on a waist by a user when exercising, and an electric inversion table that rotates so that the user's head faces the ground.

### BACKGROUND ART

Recently, there has been a growing trend for many people to exercise in order to maintain their physical health and improve their physique. As a result, the health industry related to home training and health clubs is thriving, and the sales volume of related sporting goods is also increasing every year. Here, sporting goods related to the health industry include a treadmill, an inversion table, indoor bicycles, and the like. At this time, the inversion table is called an inversion table in Korea, and refers to sporting goods in which the user's head rotates to face the ground.

As mentioned above, the inversion table is sporting goods that allow the user to hang down and rotate his or her upper body portion to face the ground, thereby increasing blood circulation in the body and strengthening the back muscles. Currently, as the technology for this purpose, Korean Laid-open Utility Model Publication No. 20-2020-0001625 (“massage inversion table”, published on Jul. 22, 2020), Korean Laid-open Patent Publication No. 10-2016-0019828 (“rotary plate fixing device of electric inversion table”, published on Feb. 22, 2016) and Korean Laid-open Patent Publication No. 10-2018-0046665 (“pelvic fixing device for inversion table sporting goods”, published on May 9, 2018), and the like are disclosed. At this time, a general inversion table will be explained with reference to FIG. 1 as follows.

The inversion table shown in FIG. 1 is configured to include a support frame 1, a rotary rod 2, a backrest 3, a footrest 4, and a massage part 5. At this time, in the inversion table shown in FIG. 1, the backrest 3 is rotatably installed on the rotary rod 2 that connects a pair of support frames 1, and the footrest 4 for fixing legs may be placed below the backrest 3.

While general inversion tables has an effect of strengthening the waist by concentrating and fixing the user's weight on the feet, since an excessive force is concentrated on the lower body, such as the ankles and knees, there is an disadvantage that injury occurs and users may not be able to use the product for long periods of time. Along with this, there was a problem in that the weight of the upper body was concentrated on the legs, impeding the effectiveness of exercise.

### DISCLOSURE

### Technical Problem

The present invention was devised to solve the problems of the related art, and an object of the present invention is to provide a pelvic/waist protector that is brought closer to the user's pelvis and waist parts through oil pressure, and an electric inversion table to which the pelvic/waist protector is attached so that the user's weight can be supported through the pelvis and waist.

### Technical Solution

In order to achieve the above object, the pelvic/waist protector according to the present invention includes a belt main body of which length extends to both ends so that an inner surface wraps around a user's pelvis and waist; an air tube which is disposed on the inner surface of the belt main body and whose volume is variable by fluid; and a dispersion member extending to a lower side of the belt main body, in which the dispersion member may be formed to be pulled toward a lower side of the waist of the user.

Further, the dispersion member may have a shape in which an upper end is fixed to the belt main body and narrows toward the lower end, and may be formed with a pair of corner parts spaced apart from each other in a longitudinal direction of the belt main body, and the pair of corner parts may be formed to have different lengths from each other.

Furthermore, the pair of corner parts may have a length ratio of one corner part to the other corner part is between 3:7 and 5:5.

Further, the dispersion member may be made up of a pair of members, and include a first dispersion member and a second dispersion member, and the first dispersion member and the second dispersion member may be spaced apart from each other in the longitudinal direction of the belt main body.

Further, each of the first dispersion member and the second dispersion member may be formed so that a length of the corner part adjacent to an end of the belt main body is longer than a length of a relatively spaced corner part.

Furthermore, the electric inversion table according to the present invention for achieving the above object may include the aforementioned pelvic/waist protector; a first actuator that applies a rotational force; a rotary unit that is coupled with the pelvic/waist protector and rotates in connection with the first actuator; and a support unit fixed onto the bottom to support the first actuator and the rotary unit, in which the pelvic/waist protector may further include a connecting ring disposed at a lower end of the dispersion member, and the rotary unit may include a fastening member to which the connecting ring is fastened.

Furthermore, the rotary unit may include a rotary body connected to the first actuator to receive power, a coupling body spaced apart from the rotary body and coupled to the pelvic/waist protector, and a connecting body that connects the rotary body and the coupling body.

Also, the coupling body may include a fixing frame having one end connected to the connecting body, an adjusting frame disposed on the other end of the fixing frame and having a length variable in a direction of both ends of the fixing frame, and a connecting ring disposed at an upper end of the adjusting frame,

Furthermore, the rotary unit may further include a lower body support unit disposed between the rotary body and the connecting body to prevent the legs of the user from being detached.

Also, the electric inversion table according to the present invention further include a second actuator fixed onto the support unit to regulate a flow rate of fluid in the air tube of the pelvic/waist protector; a first switch configured to control the first actuator; and a second switch configured to control the second actuator, in which the first switch and the second switch are placed in directions opposite to each other on the basis of the pelvic/waist protector.

### Advantageous Effects

The pelvic/waist protector according to the present invention and the electric inversion table using the same having the above configuration have an effect capable of supporting the user's weight through the pelvis, thereby strengthening the waist, correcting a posture, alleviating pain and improving the flexibility of the waist. In addition to this, there are advantages that it is possible to prevent injuries and pain caused by weight concentrated on the legs, and the pelvic/waist protector may be pulled from the lower body and supported through the pelvis, making the user more comfortable.

Furthermore, the pelvic/waist protector according to the present invention and the electric inversion table using the same have an effect of alleviating back pain by being able to fit tightly using an air tube, even if the user's waist circumference changes depending on the posture. Further, there is an advantage that the user may change the oil pressure using a second switch even when the posture has changed.

Furthermore, the pelvic/waist protector according to the present invention and the electric inversion table using the same have an advantage that safety is further improved by being configured such that weight is placed on the back of the user's waist through a dispersion member including edges formed at different lengths.

### DESCRIPTION OF DRAWINGS

FIG. 1 is diagram showing an inversion table according to the prior art of the present invention.

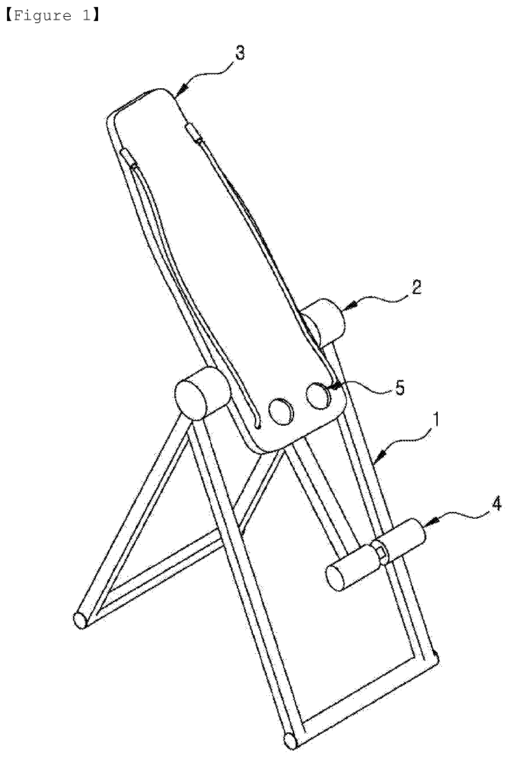

FIG. 2 is a front view showing an electric inversion table according to the present invention.

FIG. 3 is a front perspective view of a pelvic/waist protector according to the present invention.

FIG. 4 is a rear perspective view of the pelvic/waist protector according to the present invention.

FIG. 5 is a developed view of the pelvic/waist protector according to the present invention.

FIG. 6 is a side view of an electric inversion table according to the present invention.

FIGS. 7 and 8 are diagrams showing operation examples of the electric inversion table according to the present invention.

### BEST MODE

Hereinafter, a pelvic/waist protector according to the present invention and an electric inversion table using the same will be described in detail with reference to the accompanying drawings. The drawings introduced below are provided as examples to enable those skilled in the art to fully convey the spirit of the invention. Accordingly, the present invention is not limited to the drawings presented below, but may be embodied in other forms. Moreover, same reference numbers refer to same elements throughout the specification.

Unless otherwise defined, the technical terms and scientific terms used here shall have the meanings commonly understood by a person having ordinary knowledge in the technical field to which this invention pertains, and the following explanations and attachments will t provide descriptions of well-known functions and configurations that may unnecessarily obscure the gist of the present invention.

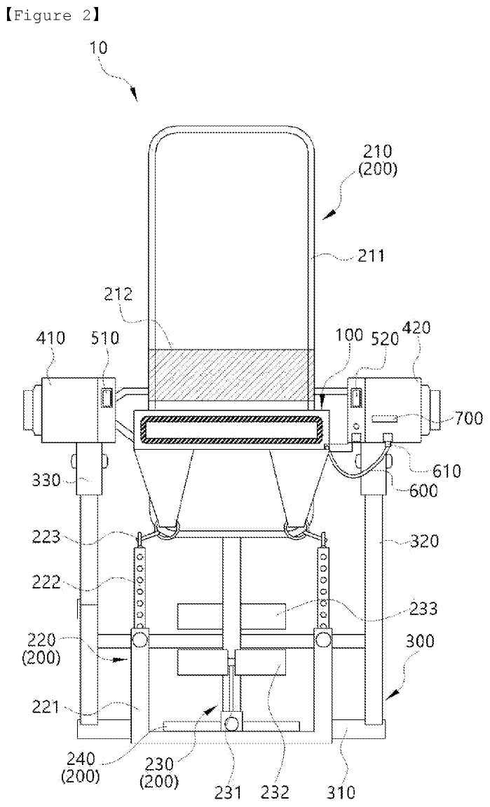

FIG. 2 relates to a pelvic/waist protector according to the present invention and an electric inversion table using the same, and FIG. 2 shows a front view of the electric inversion table to which the pelvic/waist protector is attached.

Referring to FIG. 2, the electric inversion table 10 according to the present invention may be configured to include a pelvic/waist protector 100, a rotary unit 200, and a support unit 300. At this time, the pelvic/waist protector 100 has a configuration that wraps around the user's pelvis and waist, and can be coupled to the rotary unit 200, and the rotary unit 200 can be rotated through a rotational force applied to the first actuator 410 fixed to the support unit 300. Hereinafter, for a clearer explanation, a direction passing through the drawings will be defined as a front-rear direction, and a vertical direction and a left-right direction will be defined and described on the basis of the drawings. At this time, since the posture of the rotary unit 200 may change as it rotates about the rotary axis, the posture shown in FIG. 2 will be described as a reference.

The rotary unit 200 may include a rotary body 210, a coupling body 220, a lower body support unit 230, or a connecting body 240. At this time, the rotary body 210 can be connected to the first actuator 410, and when power is transmitted from the first actuator 410 formed by a motor or the like, the rotary body 210 can rotate around the rotary axis extending in the left-right direction. The rotary body 210 may include an upper frame 211 opposite to the user's upper body position, and a pedestal 212 provided on the upper frame 211 so as to be able to partially receive the user's body weight. Here, the first actuator 410 may apply the rotational force to the upper frame 211.

The pelvic/waist protector 100 can be coupled to the coupling body 220, and can be disposed apart from the rotary body 210 in the front-rear direction. The connecting body 240 may connect the rotary body 210 and the coupling body 220, and the lower body support unit 230 may be disposed between the rotary body 210 and the connecting body 240. As an example, the rotary body 210 and the lower body support unit 230 are disposed on the front side, and the rotary body 210 and the lower body support unit 230 may be connected to each other in the vertical direction. Further, a lower end of the lower support unit 230 and a lower end of the coupling body 220 may be connected through the connecting body 240, and since the user may place his or her feet on the connecting body 240 to use, it may also be utilized as a foothold. At this time, the coupling body 220 may be disposed on the rear side.

The lower support unit 230 may include a support rod 231 that extends in the vertical direction and has an upper end coupled to the upper frame 211 of the rotary body 210 and a lower end connected to the connecting body 240, and one or more detachment prevention member fixed on the support rod 231. As an example, the lower body support unit 230 may include a first detachment prevention member 232 disposed at the front and a second detachment prevention member 233 disposed at the rear. Therefore, the first detachment prevention member 232 and the second detachment prevention member 233 may prevent the user's legs from detaching forward and backward.

The coupling body 220 may include a fixing frame 221, an adjusting frame 222, and a fastening member 223. The fixing frame 221 may have a shape in which a lower end is coupled with the connecting member 240 and extends upward, and a pair or a plurality of fixing frames 221 may be provided in the left-right direction. At this time, as shown, it will be described assuming that it is formed by a pair of fixing frames 221. One of the pair of fixing frames 221 may be coupled to the left end portion of the connecting member 240, and the other fixing frame 221 may be coupled to the right end portion of the connecting member 240. The pair of fixing frames 221 may extend upward. The adjusting frame 222 is also configured as a pair and may be connected to the upper part of the pair of fixing frames 221. At this time, a length of the adjusting frame 222 may be variable because the length may be adjustable in the vertical direction on the fixing frame 221. A fastening member 223 may be disposed at the upper end of the adjusting frame 222, and the pelvic/waist protector 100 may be coupled to the fastening member 223. Therefore, the length of the adjusting frame 222 is variable depending on the user's body, and the pelvic/waist protector 100 may be provided to be attachable to the vicinity of the user's pelvis and waist. Further, the fastening members 223 may be configured such that the upper ends are inclined toward the user's legs, and when the pair of fastening members 223 are spaced apart in the left-right direction, the fastening members 223 may be in the form in which the upper ends re bent toward the sides opposite to each other.

The support unit 300 may be placed on the floor and fixed in position, and may include a bottom member 310, a support frame 320 and a height adjustment member 330. The support frame 320 may have a structure extending vertically, and the bottom member 310 may be disposed at the lower end of the support frame 310 to be fixed or closely attached to the floor. The height adjustment member 330 is disposed on the support frame 320, and a vertical height thereof may be variable. Here, the electric inversion table 10 according to the present invention includes a first actuator 410, a second actuator 420, a first switch 510 and a second switch 520 placed on the upper part of the support unit 300.

The first actuator 410 is formed of an electric motor such as a motor, as described above, and may generate power capable of rotating the rotary unit 200. Also, the second actuator 420 may be formed of an air pressure device or the like to inject fluid into or discharge fluid from the pelvic/waist protector 100. Also, the first switch 510 and the second switch 520 may control the first actuator 410 and the second actuator 420, respectively, and may be disposed to be exposed to the outside and operated by the user. Here, in the electric inversion table 10 according to the present invention, a pair of support units 300 are disposed to be spaced apart in the left-right direction, and the pelvic/waist protector 100 and the rotary unit 200 can be disposed therebetween. A first actuator 410 and a first switch 510 are disposed on the upper part of one support unit 300, and a second actuator 420 and a second switch 520 are disposed on the upper part of the other support unit 300 and may be controlled through both hands by the user.

The electric inversion table 10 according to the present invention may further include a connection hose 600 for connecting the second actuator 420 and the pelvic/waist protector 100, and a detachable member 610 that causes the connection hose 600 to be attached to and detached from the pelvic/waist protector 100 or the second actuator 420. Accordingly, the user may couple the connection hose 600 while wearing the pelvic/waist protector 100 to receive the fluid from the second actuator 420, and may use it so that the connection hose 600 is separated when exercising. Furthermore, the electric inversion table 10 according to the present invention may further include a PSI measuring unit 700. At this time, the PSI measuring unit 700 may be disposed near the second switch 520 to measure the pressure of the fluid injected from the second actuator 420 and display it to the user.

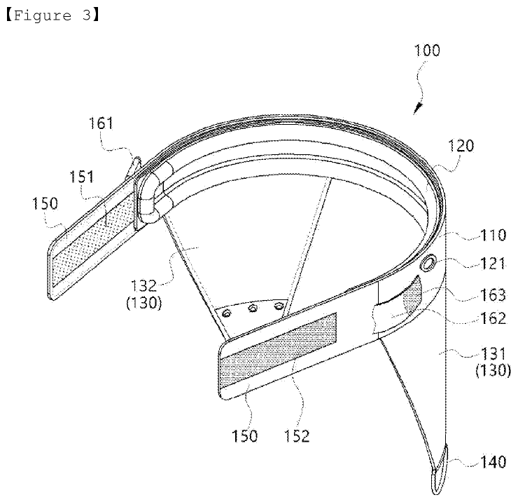

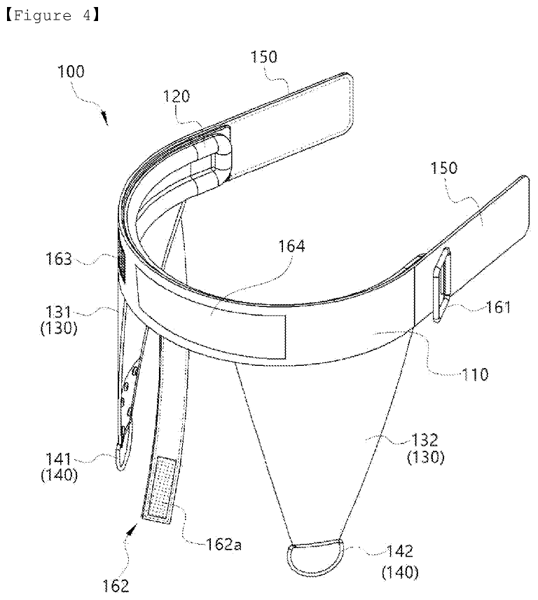

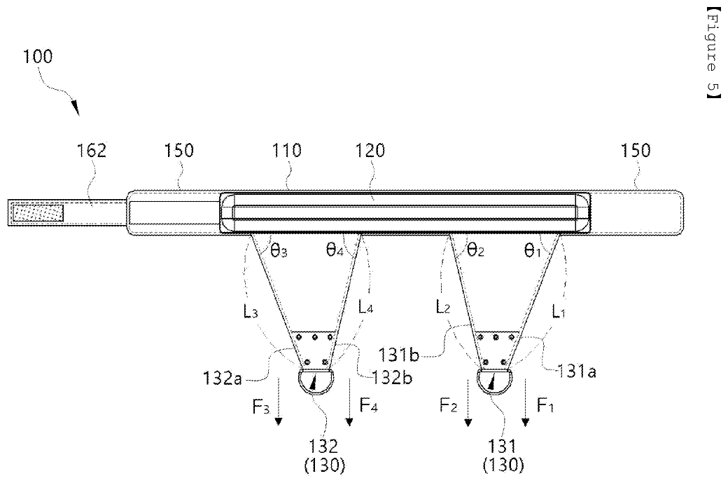

FIGS. 3 to 5 relate to a pelvic/waist protector according to the present invention and an electric inversion table using the same, FIG. 3 shows a front side perspective view of the pelvic/waist protector, FIG. 4 shows a rear side perspective view of the pelvic/waist protector, and FIG. 5 shows a developed view showing the inner surface of the pelvic/waist protector.

Referring to FIGS. 3 and 4, the pelvic/waist protector 100 according to the present invention may include a belt main body 110, an air tube 120, and a dispersion member 130. At this time, the belt main body 110 is a structure disposed to wrap the user's pelvis and waist, and the air tube 120 may be disposed on the inner surface thereof. At this time, the inner surface means a surface adjacent to the user's pelvis and waist among both surfaces of the belt main body 110, and the outer surface may be an opposite surface thereto. Here, the air tube 120 may be provided with variable pressure and volume as fluid is injected or discharged as described above, and may be provided so that the device is brought closer to the user's pelvis and waist. As a result, when the user's head rotates to faces the ground, the user's weight may be placed on a region to which the air tube 120 is brought closer. Also, the dispersion member 130 may be coupled to the lower side of the belt main body 110, and may be in the form extending downward. At this time, the lower side or lower part may be in the direction of the user's lower body. Here, a fluid inlet 121 communicating with the air tube 120 is formed on the outer surface of the belt main body 110, and may be configured to inject fluid into the air tube 120 or discharge the fluid inside the air tube 120.

The dispersion member 130 may be placed on the body in the lower part of the waist, such as femoral muscle, iliac muscle, and pelvis, and may be placed so that the weight may be dispersed into the pelvis and the waist. At this time, the dispersion member 130 may be made up of a pair or a plurality of pieces, and for a clearer explanation, a pair of dispersion members 130 including a first dispersion member 131 and a second dispersion member 132 will be explained as an example. The belt main body 110 may have a length extending around the user's waist, the first dispersion member 131 is disposed at one end of the belt main body 110 in a longitudinal direction, and the second dispersion member 132 may be placed at the other end of the belt main body 110 in the longitudinal direction. The dispersion member 130 may be configured to have a shape that becomes narrower from the top to the bottom, and at this time, the narrower shape may be a shape that has a narrower width corresponding to the longitudinal direction of the belt main body 110. Therefore, the dispersion member 130 may have a shape such as a triangle or trapezoid. Here, the pelvic/waist protector 100 according to the present invention may further include a connecting ring 140 that is coupled to the lower end of the dispersion member 130 and coupled onto the fastening member 223 of the inversion table 10 as described above. At this time, the connecting ring 140 may include a first connecting ring 141 and a second connecting ring 142 that are disposed on the first dispersion member 131 and the second dispersion member 132, respectively. At this time, the connecting ring 140 may be disposed so that the lower end thereof is bent to the user's body.

The pelvic/waist protector 100 according to the present invention may further include means which enable the belt main body 110 and the air tube 120 to be fixed on the user's pelvis and waist. More specifically, the pelvic/waist protector 100 according to the present invention may include a first joining member 151 disposed on one end side of the belt main body 110 and a second joining member disposed on the other end side of the belt main body 110, and as the first joining member 151 is disposed on the inner surface and the second joining member 152 is disposed on the outer surface, the joining members may be coupled to each other. As an example, the first joining member 151 and the second joining member 152 may be coupled in the form of Velcro. At this time, the pelvic/waist protector 100 according to the present invention may further include an extension part 150 extending to one end or the other end of the belt main body 110, and the first joining member 151 or the second joining member 152 may be disposed on the extension part 150.

The pelvic/waist protector 100 according to the present invention may further include a fixing ring 161 having one end fixed on the belt main body 110, a waistband 162, and the like. The pelvic/waist protector 100 according to the present invention may further include an auxiliary fastening unit so that the waistband 162 may be fixed after the waistband 162 passes through a through-hole of the fixing ring 161. At this time, the auxiliary fastening unit may further include a first auxiliary fastening unit 162a disposed on the inner surface of the other end of the waistband 162, and a second auxiliary fastening unit 163 disposed on the outer surface of the belt main body 110 or the outer surface of one end of the waistband 162. Further, a fixing adhesive unit 164 may be disposed on the outer surface of the belt main body 110, and the fixing adhesive unit 164 is formed to be attachable to and detachable from the rotary unit 200 of the above-mentioned inversion table 10, and may be configured to fix the user's body when exercising. More preferably, the fixing adhesive unit 164 may be fixedly adhered to the rotary body 210 of the rotary unit 200.

Referring to FIG. 5, the dispersion member 130 may include a pair of corner parts inclined in the longitudinal direction of the belt main body 110 on the basis of the vertical direction. At this time, one corner part of the pair of corner parts may be inclined in a shape rotated to one end of the body 110 by a predetermined angle, and the other corner part may be inclined in a shape rotated to the other end of the body 110 by a predetermined angle. For a clearer explanation, the first dispersion member 131 and the second dispersion member 132 will be explained as an example.

The first dispersion member 131 disposed on one end side of the belt main body 110 may include a 1-1st corner part 131a and a 1-2nd corner part 131b. At this time, the 1-1st corner part 131a may be disposed to be closer to one end of the belt main body 110 than the 1-2nd corner part 131b. Here, the 1-1st corner part 131a has a first interior angle θ1 and a first length L1, and the 1-2nd corner part 131b may have a second interior angle θ2 and a second length L2. At this time, the first length L1 and the second length L2 may be formed to be different lengths from each other. As an example, a ratio of the first length L1 to the second length L2 may be formed between 3:7 and 5:5. Therefore, the first interior angle θ1 and the second interior angle θ2 may also be formed at different angles from each other. More preferably, the ratio of the first length L1 to the second length L2 may be formed between 4:6 and 4.5:5.5.

The second dispersion member 132 disposed on the other end side of the belt main body 110 may include a 2-1st corner part 132a and a 2-2nd corner part 132b. At this time, the 2-1st corner part 132a may be disposed to be closer to the other end of the belt main body 110 than the 2-2nd corner part 132b. Here, the 2-1st corner part 132a may have a third interior angle θ3 and a third length L3, and the 2-2nd corner part 132b may have a fourth interior angle θ4 and a fourth length L4. At this time, the third length L3 and the fourth length L4 may be formed to be different lengths from each other. As an example, a ratio of the third length L3 to the fourth length L4 may be formed between 3:7 to 5:5. Therefore, the third internal angle θ3 and the fourth internal angle θ4 may also be formed at different angles from each other. Even more preferably, the ratio of the third length L3 to the fourth length L4 may be formed between 4:6 and 4.5:5.5. In this way, the belt main body 110 may be pulled through the dispersion member 130 to apply weight to the user's pelvis and waist, and different forces F1 and F2 are applied to the 1-1st corner part 131a and the 1-2nd corner part 131b formed at different lengths from each other, and may be evenly dispersed to the user's body. Moreover, the 2-1st corner part 132a and the 2-2nd corner part 132b may also be configured so that different forces F3 and F4 are applied to the user's body.

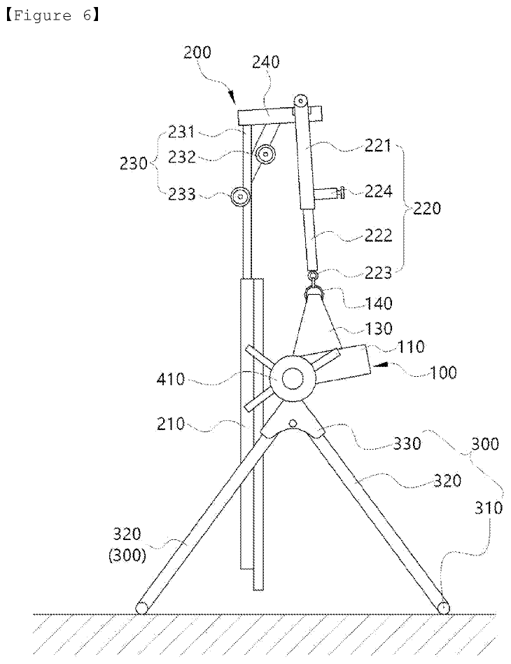

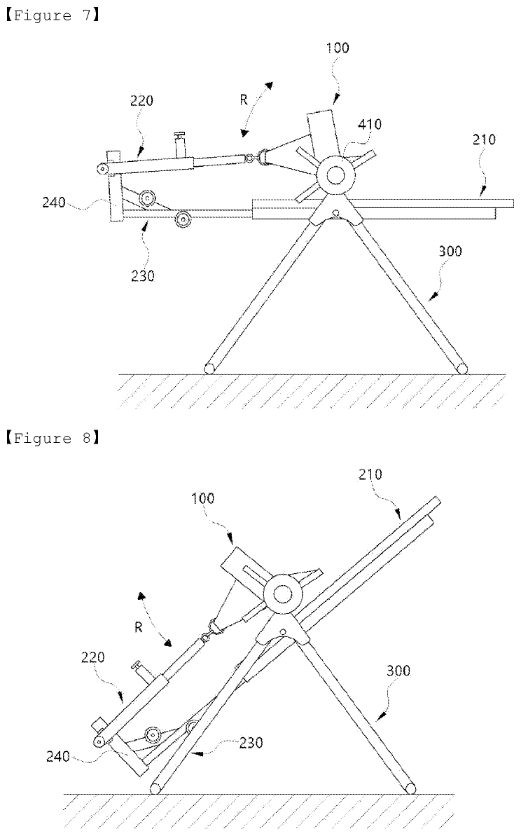

FIGS. 6 to 8 relate to the pelvic/waist protector according to the present invention and the electric inversion table using the same, FIG. 6 shows a side view of the electric inversion table, and FIGS. 7 and 8 show operation example diagrams of the electric inversion table, respectively.

Referring to FIG. 6, when the connecting body 240 faces upward while the user is wearing the pelvic/waist protector 100, it may be configured so that the user's weight may be supported the pelvis and the waist via the belt main body 110, the dispersion unit 130, and the connecting ring 140 of the pelvic/waist protector 100. Also, as the dispersion unit 130 is disposed below the user's waist and is pulled by the lower body of the user, the body weight may be partially dispersed. Further, the user may fix legs to the first detachment prevention member 232 and the second detachment prevention member 233 of the lower body support unit 230, and a part of the body weight may be dispersed through the top of foot.

An angle formed between the rotary body 210 and the lower body support unit 230 with the connecting body 240 is the same as an angle formed between the coupling body 220 and the connecting body 240, or the coupling body 220 forms an obtuse angle, and an interval between the rotary body 210 and the coupling body 220 or an interval between the lower body support unit 230 and the coupling body 220 may be configured to become wider toward the upper body of the user. At this time, the obtuse angle may lead to the advantage that even obese users may use it more conveniently.

Referring to FIGS. 7 and 8, the user may control the angle adjustment through the first actuator 410 by operating the first switch 510 as described above. That is, when the first actuator 410 applies power, the rotary body 210 rotates, and the coupling body 220, the lower body support unit 230, and the connecting body 240 connected to the rotary body 210 may also rotate together.

Although the present invention has been described above by specific matters such as specific components and limited exemplary drawings, these are merely provided to aid in a more comprehensive understanding of the present invention, the present invention is not limited to the above-mentioned embodiment, and those having ordinary knowledge in the field to which the invention pertains present may make various modifications and variations from these descriptions.

Accordingly, the spirit of the invention should not be limited to the described embodiments, and it should be understood that not only the following claims, but also all equivalent to the claims or equivalent variations are within the spirit of the present invention.

### DESCRIPTION OF SYMBOLS

10: Electric inversion table
100: Pelvic/waist protector
110: Belt main body 120: Air tube
121: Air inlet
130: Dispersion member
131: First dispersion member
131a: 1-1st corner part 131b: 1-2nd corner part
132: Second dispersion member
132a: 2-1st corner part 132b: 2-2nd corner part
140: Connecting Ring
141: First connecting ring 142: Second connecting ring
150: Extension part
151: First joining member 152: Second joining member
161: Fixing ring 162: Waistband
162a: First auxiliary fastening unit 163: Second auxiliary fastening unit
164: Fixing adhesive unit
200: Rotary unit
210: Rotary body 211: Upper frame
212: Pedestal
220: Coupling body 221: Fixing frame
222: Adjusting frame 223: Fastening member
230: Lower body support unit 231: Support rod
232: First detachment prevention member 233: Second detachment prevention member
240: Connecting body
300: Support unit 310: Floor member
320: Support frame 330: Height adjustment member
410: First actuator 420: Second actuator
510: First switch 520: Second switch
600: Connection hose 610: Detachable member
700: PSI measuring unit

1. An electric inversion table, comprising:
a pelvic/waist protector which includes a belt main body of which length extends to both ends so that an inner surface wraps around a user's pelvis and waist, an air tube which is disposed on the inner surface of the belt main body and whose volume is variable by fluid, and a dispersion member extending to a lower side of the belt main body;
a first actuator that applies a rotational force; and
a rotary unit that is coupled to the pelvic/waist protector and rotates in connection with the first actuator,
wherein the pelvic/waist protector further includes a connecting ring disposed at a lower end of the dispersion member,
the rotary unit includes a rotary body connected to the first actuator to receive power, a coupling body spaced apart from the rotary body and coupled to the pelvic/waist protector, and a connecting body that connects the rotary body and the coupling body, and
the coupling body further includes a fixing frame having one end connected to the connecting body, an adjusting frame disposed on the other end of the fixing frame and having a length variable in a direction of both ends of the fixing frame, and a fastening member disposed at an upper end of the adjusting frame, wherein an upper end of the fastening member is inclined toward user's legs, and the connecting ring is coupled to the fastening member.

2. The electric inversion table according to claim 1,
wherein the dispersion member has a shape in which an upper end is fixed to the belt main body and narrows toward the lower end, and is formed with a pair of corner parts spaced apart from each other in a longitudinal direction of the belt main body, and
the pair of corner parts are formed to have different lengths from each other.

3. The electric inversion table according to claim 2,
wherein the pair of corner parts has a length ratio of one corner part to the other corner part is between 3:7 and 5:5.

4. The electric inversion table according to claim 2,
wherein the dispersion member is made up of a pair of members, and includes a first dispersion member and a second dispersion member, and
the first dispersion member and the second dispersion member are spaced apart from each other in the longitudinal direction of the belt main body.

5. The electric inversion table according to claim 1,
wherein each of the first dispersion member and the second dispersion member is formed so that a length of the corner part adjacent to an end of the belt main body is longer than a length of a relatively spaced corner part.

6. The electric inversion table according to claim 1,
wherein the electric inversion table further comprises a support unit fixed onto a bottom to support the first actuator and the rotary unit.

7. The electric inversion table according to claim 1,
wherein the rotary unit further comprises a lower body support unit disposed between the rotary body and the connecting body to prevent the legs of the user from being detached.

8. The electric inversion table according to claim 6, further comprising:
a second actuator fixed to the support unit to regulate a flow rate of fluid in the air tube of the pelvic/waist protector;
a first switch configured to control the first actuator; and
a second switch configured to control the second actuator,
wherein the first switch and the second switch are placed in directions opposite to each other on the basis of the pelvic/waist protector.
